(19) United States
(12) Patent Application Publication
(10) Pub. No.: US 2025/0385397 A1
(43) Pub. Date: Dec. 18, 2025

(54) FOLDED LEAD TABS

(71) Applicant: Apple Inc., Cupertino, CA (US)

(72) Inventors: Samuel C. Billand, San Francisco, CA (US); Pranjal K. Naik, Cupertino, CA (US); Steven M. Labovitz, Sunnyvale, CA (US); Karl A. Gazdowski, Los Gatos, CA (US)

(21) Appl. No.: 19/210,735

(22) Filed: May 16, 2025

Related U.S. Application Data
(60) Provisional application No. 63/659,746, filed on Jun. 13, 2024.

(51) Int. Cl. H01M 50/533; H01M 4/66; H01M 50/528; H01M 50/536; H01M 50/54

(52) U.S. Cl. CPC H01M 50/533; H01M 4/661; H01M 50/528; H01M 50/536; H01M 50/54

(57) ABSTRACT

Aspects of the present disclosure involve folded electrode tabs. In general, a battery pack includes a battery cell, an enclosure enclosing the battery cell, a feedthrough tab configured to form a battery terminal, and a lead tab. The battery cell includes a stack of electrodes and a plurality of electrode tabs extending from the stack of electrodes. The lead tab includes a first portion connected to the plurality of electrode tabs, a second portion connected to the feedthrough tab, and a third portion connecting the first portion to the second portion such that the first portion and the second portion at least partially overlap and reside in substantially separate parallel planes. The plurality of electrode tabs extend from the stack of electrodes in a direction that is substantially parallel to both the first portion and the second portion.

### PRIORITY

The disclosure claims the benefit under 35 U.S.C. § 119(e) of U.S. Provisional Patent Application No. 63/659,746 entitled “Folded Lead Tabs”, filed on Jun. 13, 2024, which is incorporated herein by reference in its entirety.

### TECHNICAL FIELD

This disclosure relates generally to lead tabs, and more specifically to folded lead tabs.

### BACKGROUND

Many battery packs include a battery cell and an enclosure enclosing the battery cell. The battery cell can include an electrode stack from which electrode tabs, such as electrode foils, extend. Each of the electrode tabs can be connected to a lead tab, which can operate as a main electrical terminal for the battery cell. The electrode tabs and/or the lead tab can be folded, with the folded portion being housed in a gap between the electrode stack and an inner wall of the enclosure. However, folding the electrode tabs can deform the electrode tabs. Further, the folded portion occupies valuable space within the enclosure, thereby reducing the potential energy density of the battery pack. It is with these and other issues in mind that various aspects of the present disclosure were developed.

### SUMMARY

In one aspect, the disclosure is directed to a battery pack with no-fold electrode tabs. In general, the battery pack can include a battery cell. The battery cell can include a stack of electrodes and a plurality of electrode tabs extending from the stack of electrodes. The battery pack can include an enclosure enclosing the battery cell. The battery pack can include a feedthrough tab configured to form a battery terminal. The battery pack can include a lead tab. The lead tab can include a first portion connected to the plurality of electrode tabs, a second portion connected to the feedthrough tab, and a third portion connecting the first portion to the second portion such that the first portion and the second portion at least partially overlap and reside in substantially separate parallel planes. The plurality of electrode tabs extend from the stack of electrodes in a direction that is substantially parallel to both the first portion and the second portion.

In a further aspect, the disclosure is directed to a method for inserting a stack of electrodes into an enclosure. A first portion of a lead tab can be connected to a plurality of electrode tabs extending from a stack of electrodes. A second portion of the lead tab can be connected to a feedthrough tab configured to form a battery terminal. The stack of electrodes can be inserted within an enclosure by rotating a third portion of the lead tab around a fixed point such that the first portion and the second portion at least partially overlap and reside in substantially separate parallel planes. The plurality of electrode tabs can extend from the stack of electrodes in a direction that is substantially parallel to both the first portion and the second portion.

### BRIEF DESCRIPTION OF THE DRAWINGS

Although the following figures and description illustrate specific embodiments and examples, the skilled artisan will appreciate that various changes and modifications may be made without departing from the spirit and scope of the disclosure.

FIG. 1 is a side view of a battery pack with no-fold electrode tabs.

FIG. 2 is a side view of a battery pack with no-fold electrode tabs.

FIGS. 3A-C illustrate the insertion of a battery cell into an enclosure.

FIG. 4 illustrates example enclosures.

FIG. 5 illustrates an example method for inserting a stack of electrodes into an enclosure.

FIG. 6 is a portable electronic device.

### DETAILED DESCRIPTION

As noted above, aspects of the present disclosure involve a battery pack that includes no-fold electrode tabs. In general, the battery pack can include a battery cell. The battery cell can include a stack of electrodes and a plurality of electrode tabs extending from the stack of electrodes. The battery pack can include an enclosure enclosing the battery cell. The battery pack can include a feedthrough tab configured to form a battery terminal. The battery pack can include a lead tab. The lead tab can include a first portion connected to the plurality of electrode tabs, a second portion connected to the feedthrough tab, and a third portion connecting the first portion to the second portion such that the first portion and the second portion at least partially overlap and reside in substantially separate parallel planes. The plurality of electrode tabs extend from the stack of electrodes in a direction that is substantially parallel to both the first portion and the second portion.

Through this particular battery pack design, several advantages may be obtained over conventional battery packs. For example, a conventional battery pack can include electrode tabs that have been connected to a lead tab and folded, with the folded portion being housed in a gap between the electrode stack and an inner wall of the enclosure. This folded portion can function as a service loop that absorbs mechanical impacts on the enclosure, such as in the case of the battery pack being dropped, to prevent a failure of the stack of electrodes. However, folding the electrode tabs can damage or deform the electrode tabs. Further, the folded portion occupies valuable space within the enclosure, thereby reducing the potential energy density of the battery pack.

Instead of housing the service loop in a gap between the electrode stack and an inner wall of the enclosure, the improved battery pack described herein includes a service loop that does not occupy any space between the electrode stack and an inner wall of the enclosure. Instead, the improved battery pack described herein includes a folded lead tab forming a service loop in a feed-through region of the battery pack. The reduction in material stack-up in the gap between the electrode stack and the inner wall of the enclosure can facilitate an increase in size of the electrode stack, thereby leading to improvements in the energy density of the battery pack. Further, by moving the service loop out of the gap between the electrode stack and an inner wall of the enclosure and into the feed-through region of the battery pack, the electrode tabs are less likely to become deformed.

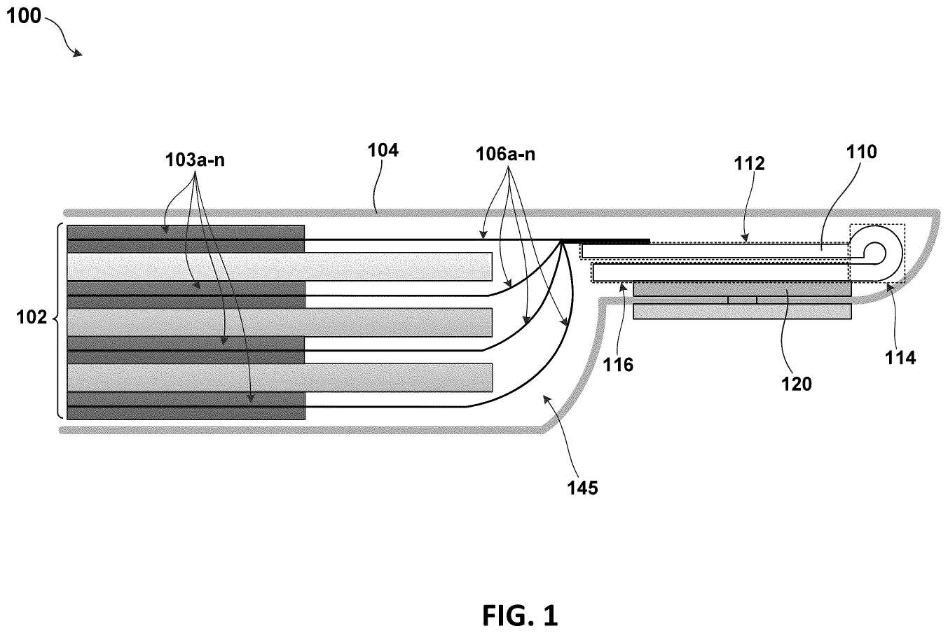

FIG. 1 is a side view of battery pack 100 including a folded lead tab forming a service loop in a feed-through region of the battery pack. The battery pack 100 includes a battery cell 102. The battery cell 102 includes a first stack of electrodes 103a-n and a first plurality of electrode tabs 106a-n extending from the first stack of electrodes 103a-n. Each electrode in the first stack of electrodes 103a-n can be an anode layer. Each electrode tab of the first plurality of electrode tabs 106a-n can be an anode current collector. Each anode current collector can be a material comprising at least one of copper and nickel, such as a copper and/or nickel foil.

The battery pack 100 can include an enclosure 104 enclosing the battery cell 102. The enclosure 104 can be a pouch or a hard container. The enclosure 104 can include a plurality of faces (e.g., sides). For example, the enclosure may comprise a top face, a bottom face, and one or more side faces. However, it should be appreciated that the enclosure may be any size or shape and may include any number of faces and/or angles. The battery pack 100 can include a feedthrough tab 120. The feedthrough tab 120 can form an external battery terminal, such as a negative battery terminal.

The battery pack 100 can include a lead tab 110. The lead tab 110 can include a first portion 112. The first portion 112 can be connected to the first plurality of electrode tabs 106a-n. The first portion 112 can be connected to the first plurality of electrode tabs 106a-n via an ultrasonic weld or any other suitable type of connection. The lead tab 110 can include a second portion 116. The second portion 116 can be connected to the feedthrough tab 120. The second portion 116 can be connected to the feedthrough tab 120 via a laser weld or any other suitable type of connection.

The lead tab 110 can include a third portion 114. The third portion 114 can connect the first portion 112 to the second portion 116 such that the first portion 112 and the second portion 116 at least partially overlap. The first portion 112 and the second portion 116 can reside in substantially separate parallel planes. The second portion 116 can be positioned substantially underneath the first portion 112, or vice versa. The first plurality of electrode tabs 106a-n can extend from the stack of electrodes 103a-n in a direction that is substantially parallel to both the first portion 112 and the second portion 116. The third portion 114 can be bent back over itself, such as to form a substantially 180 degree angle.

The first portion 112, the second portion 116, and the third portion 114 can collectively form a service loop in the feed-through region of the battery pack 100. The service loop can absorb a mechanical impact on the enclosure 104 to prevent a failure of the battery cell 102, such as if the battery pack 100 is dropped or otherwise subjected to an external force. Housing the service loop in the feed-through region of the battery pack 100 prevents the service loop from occupying any space in a region 145 between the battery cell 102 and an inner wall of the enclosure 104. Because the region 145 is unoccupied, the size of the electrodes can be increased, creating more active area, and thereby increasing the battery energy density. Further, housing the service loop in the feed-through region of the battery pack 100 instead of in the region 145 prevents deformation of the first plurality of electrode tabs 106a-n.

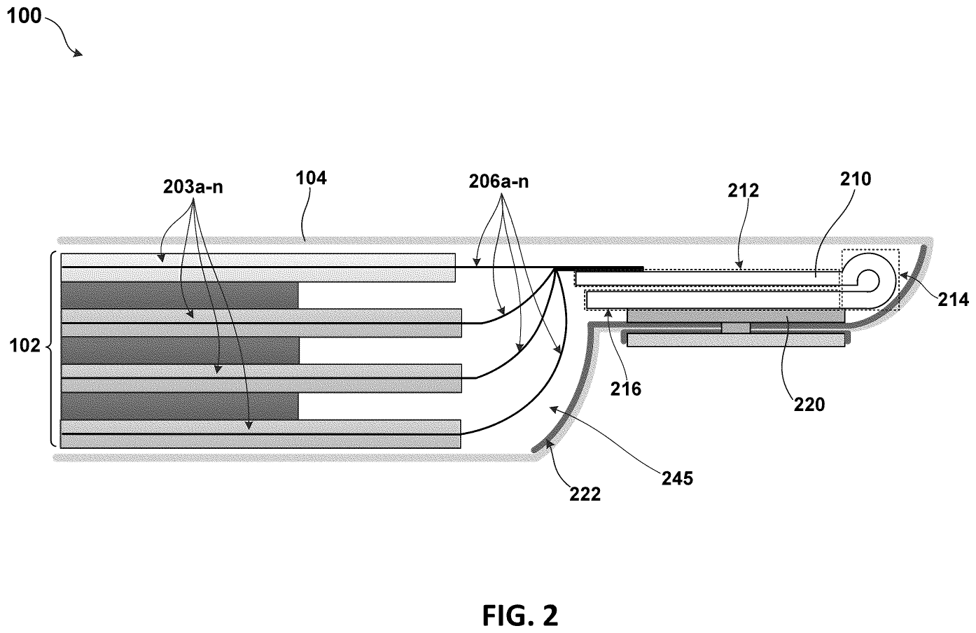

FIG. 2 is another side view of the battery pack 100 including a folded lead tab forming a service loop in a feed-through region of the battery pack. The battery cell 102 can includes a second stack of electrodes 203a-n and a second plurality of electrode tabs 206a-n extending from the second stack of electrodes 203a-n. Each electrode in the second stack of electrodes 203a-n can be a cathode layer. Each electrode tab of the second plurality of electrode tabs 206a-n can be a cathode current collector. Each cathode current collector can be a material comprising aluminum, such as an aluminum foil.

The battery pack 100 can include a feedthrough tab 220. The feedthrough tab 220 can form an external battery terminal, such as a positive battery terminal. The battery pack 100 can include an insulator 222. The insulator 22 can be a material comprised of plastic. The insulator 222 can surround the feedthrough tab 220 such as to electrically isolate the feedthrough tab 220 from the enclosure 104.

The battery pack 100 can include a lead tab 210. The lead tab 210 can include a first portion 212. The first portion 212 can be connected to the second plurality of electrode tabs 206a-n. The first portion 212 can be connected to the second plurality of electrode tabs 206a-n via an ultrasonic weld or any other suitable type of connection. The lead tab 210 can include a second portion 216. The second portion 216 can be connected to the feedthrough tab 220. The second portion 216 can be connected to the feedthrough tab 220 via a laser weld or any other suitable type of connection.

The lead tab 210 can include a third portion 214. The third portion 214 can connect the first portion 212 to the second portion 216 such that the first portion 212 and the second portion 216 at least partially overlap. The first portion 212 and the second portion 216 can reside in substantially separate parallel planes. The second portion 216 can be positioned substantially underneath the first portion 212, or vice versa. The second plurality of electrode tabs 206a-n can extend from the stack of electrodes 203a-n in a direction that is substantially parallel to both the first portion 212 and the second portion 216. The third portion 214 can be bent back over itself, such as to form a substantially 180 degree angle.

The first portion 212, the second portion 216, and the third portion 214 can collectively form a service loop in the feed-through region of the battery pack 100. The service loop can absorb a mechanical impact on the enclosure 104 to prevent a failure of the battery cell 102, such as if the battery pack 100 is dropped or otherwise subjected to an external force. Housing the service loop in the feed-through region of the battery pack 100 prevents the service loop from occupying any space in a region 245 between the battery cell 102 and an inner wall of the enclosure 104. Because the region 245 is unoccupied, the size of the electrodes can be increased, creating more active area, and thereby increasing the battery energy density. Further, housing the service loop in the feed-through region of the battery pack 100 instead of in the region 245 prevents deformation of the second plurality of electrode tabs 206a-n.

While the battery pack 100 can include the above-described folded lead tab for both the positive and negative battery terminals, it should be appreciated that the battery pack 100 can alternatively include the above-described folded lead tab for only one of the positive and negative battery terminals.

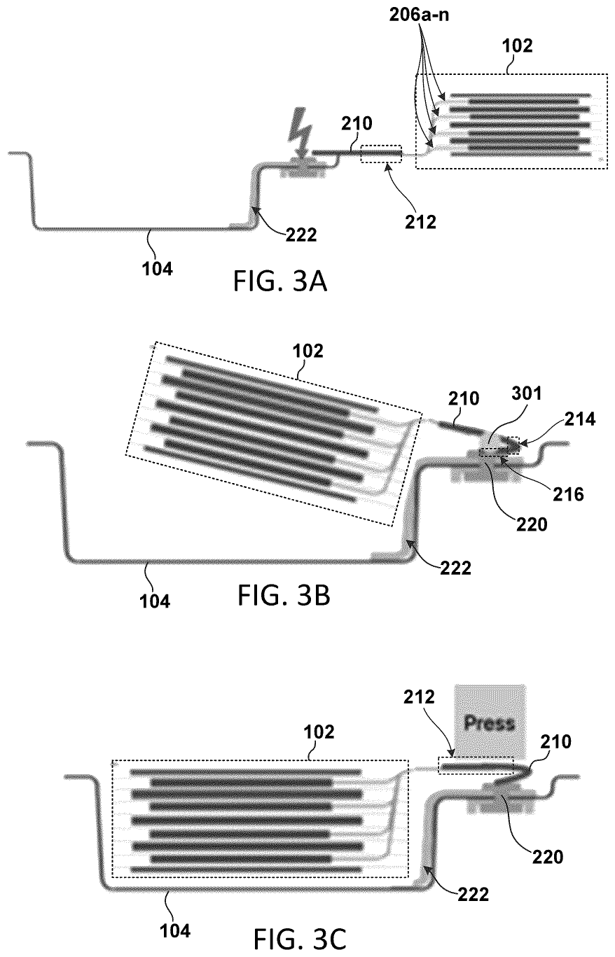

FIGS. 3A-3C illustrate a process for inserting the battery cell 102 into the enclosure 104. As shown in FIG. 3A, the first portion 212 of the lead tab 210 can be connected to the second plurality of electrode tabs 206a-n. The first portion 212 of the lead tab 210 can be connected to the second plurality of electrode tabs 206a-n via ultrasonic welding. While not pictured in FIG. 3A, the first portion 112 of the lead tab 110 can similarly be connected to the first plurality of electrode tabs 106a-n, such as via ultrasonic welding.

As shown in FIG. 3B, the second portion 216 of the lead tab 210 can be connected to the feedthrough tab 220 configured to form a battery terminal, such as positive battery terminal. The second portion 216 of the lead tab 210 can be connected to the feedthrough tab 220 via laser welding. While not pictured in FIG. 3B, the second portion 216 of the lead tab 110 can similarly be connected to the feedthrough tab 120, such as via laser welding.

The battery cell 102 can be inserted into the enclosure 104 by rotating the third portion 214 of the lead tab 210 around a fixed point 301 such that the first portion 212 and the second portion 216 at least partially overlap. While not picture in FIG. 3B, the third portion 114 of the lead tab 110 can similarly be rotated around a fixed point such that the first portion 112 and the second portion 116 at least partially overlap.

As shown in FIG. 3C, a force can be applied to the lead tab 210, such as to the first portion 212 of the lead tab 210, to cause the first portion 212 and the second portion 216 to reside in substantially separate parallel planes. The force can be applied to the lead tab 210 to cause the third portion 214 of the lead tab 210 to form a substantially 180 degree angle. The second plurality of electrode tabs 206a-n can extend from the second stack of electrodes 203a-n in a direction that is substantially parallel to both the first portion 212 and the second portion 216.

While not pictured in FIG. 3C, a force can be applied to the lead tab 110, such as to the first portion 112 of the lead tab 110, to cause the first portion 112 and the second portion 116 to reside in substantially separate parallel planes. The force can be applied to the lead tab 110 to cause the third portion 114 of the lead tab 110 to form a substantially 180 degree angle. The first plurality of electrode tabs 106a-n can extend from the first stack of electrodes 103a-n in a direction that is substantially parallel to both the first portion 112 and the second portion 116.

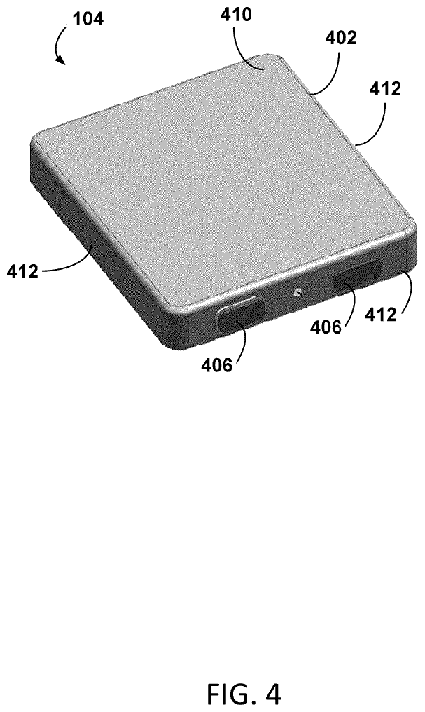

FIG. 4 illustrates an example embodiment of the enclosure 104. The enclosure 104 can include two dish or clamshell shaped outer surfaces. In particular, the enclosure 104 can include a first portion, or upper portion 402, that has an optionally flat or semi-flat surface 410 and four walls 412 that extend from the flat or semi-flat surface. In general, the dimensions (e.g., width and length) of the flat or semi-flat surface 410 are larger than the dimensions of the walls 412 such that the four walls are smaller in area than the larger flat or semi-flat surface to form a rectangular-shape with an opening along one of the larger surfaces of the rectangle. The regions of the first portion 402 where the surface 410 meets the four walls 412 may form an edge. In some embodiments the edge can have a right angle or may be rounded. Similarly, the regions of the first portion 402 where the four walls 412 meet may form a corner; in some embodiments the corner may be a right angle, an obtuse angle, an acute angle or may be rounded. In addition, one or more feedthroughs 406 may be located on a wall 412 of the first portion 402.

The enclosure 104 can also include a second portion 404. In one embodiment, the second portion 404 includes a similar shape as the first portion 402, namely, a flat or semi-flat surface 414 and four walls that extend from the surface to form a rectangular-shape with an opening along one of the larger surfaces of the rectangle. In the embodiment, the length and width of the flat or semi-flat surface 414 may include slightly smaller dimensions than corresponding dimensions of the flat or semi-flat surface 410 of the first portion 402. Thus, when mated, the walls of the second portion 404 fit inside the walls 412 of the first portion 402 to form a box-like enclosure. In another embodiment, the second portion 404 includes the flat or semi-flat surface 414. In general, the dimensions of the flat or semi-flat surface 414 of the second portion 404, in this embodiment, are the same or similar to the flat or semi-flat surface 410 of the first portion 402 such that, when mated, the first and second portion of the battery can form a box-like enclosure for housing the battery cell 102. The various walls and portions of the enclosure 104 can be a material comprising stainless steel and/or titanium.

In other embodiments, the enclosure can include a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery cell, the density of battery cell, or both.

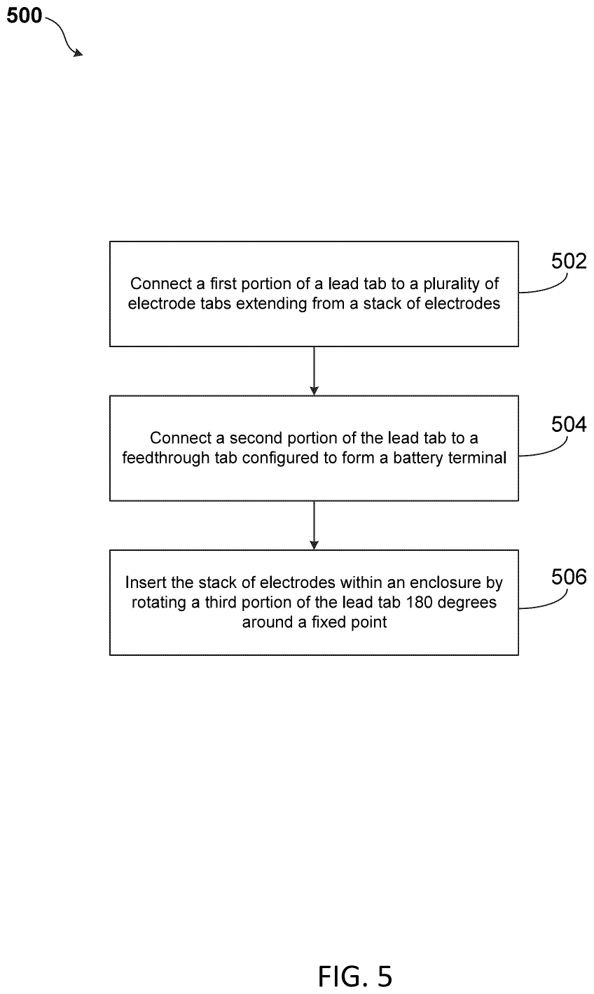

FIG. 5 illustrates an example method 500 for inserting a battery cell, such as the battery cell 102, into an enclosure, such as the enclosure 104, in accordance with various aspects of the subject technology. It should be understood that, for any process discussed herein, there can be additional, fewer, or alternative steps performed in similar or alternative orders, or in parallel, within the scope of the various embodiments unless otherwise stated.

At operation 502, the first portion 112 of the lead tab 110 can be connected to the first plurality of electrode tabs 106a-n. The first plurality of electrode tabs 106a-n can extend from the first stack of electrodes 103a-n. The first portion 112 of the lead tab 110 can be connected to the first plurality of electrode tabs 106a-n via ultrasonic welding. Each electrode tab of the first plurality of electrode tabs 106a-n can be an anode current collector.

In embodiments, the first portion 212 of the lead tab 210 can similarly be connected to the second plurality of electrode tabs 206a-n, such as via ultrasonic welding. The second plurality of electrode tabs 106a-n can extend from the second stack of electrodes 203a-n. Each electrode tab of the second plurality of electrode tabs 206a-n can be a cathode current collector.

At operation 504, a second portion 116 of the lead tab 110 can be connected to the feedthrough tab 120. The feedthrough tab 120 can be configured to form an external battery terminal, such as a negative battery terminal.

In embodiments, the second portion 216 of the lead tab 210 can be connected to the feedthrough tab 220. The feedthrough tab 220 can be configured to form an external battery terminal, such as a positive battery terminal.

At operation 506, the first stack of electrodes 103a-n can be inserted within the enclosure 104. The first stack of electrodes 103a-n can be inserted into the enclosure 104 by rotating the third portion 114 of the lead tab 110 around a fixed point such that the first portion 112 and the second portion 116 at least partially overlap and reside in substantially separate parallel planes. The first plurality of electrode tabs 106a-n can extend from the first stack of electrodes 103a-n in a direction that is substantially parallel to both the first portion 112 and the second portion 116.

In embodiments, the third portion 114 is rotated around the fixed point to cause the third portion 114 to bend back over itself. The third portion 114 can be rotated around the fixed point to cause the third portion 114 to form a substantially 180 degree angle.

In embodiments, the second stack of electrodes 203a-n can be inserted within the enclosure 104. The first stack of electrodes 103a-n and the second stack of electrodes 203a-n can be simultaneously inserted within the enclosure 104. The second stack of electrodes 103a-n can be inserted into the enclosure 104 by rotating the third portion 214 of the lead tab 210 around a fixed point such that the first portion 212 and the second portion 216 at least partially overlap and reside in substantially separate parallel planes. The second plurality of electrode tabs 206a-n can extend from the second stack of electrodes 203a-n in a direction that is substantially parallel to both the first portion 212 and the second portion 216.

In embodiments, the third portion 214 is rotated around the fixed point to cause the third portion 214 to bend back over itself. The third portion 214 can be rotated around the fixed point to cause the third portion 214 to form a substantially 180 degree angle.

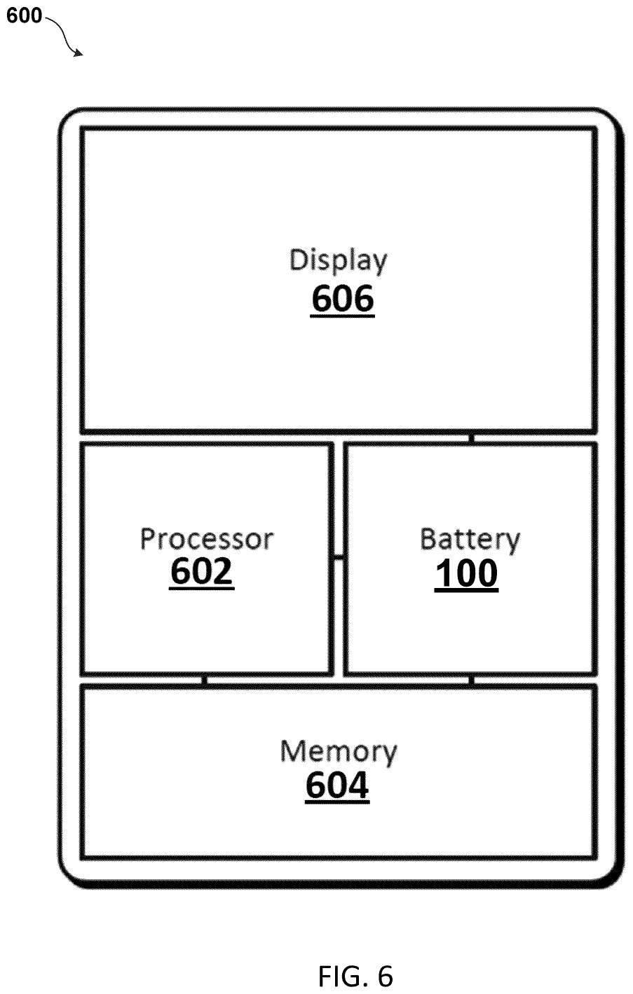

FIG. 6 illustrates a portable electronic device 600, in accordance with various aspects of the subject technology. The portable electronic device 600 includes a processor 602, a memory 604, and a display 606, which are all powered by the battery pack 100. Portable electronic device 600 may correspond to a laptop computer, tablet computer, mobile phone, personal digital assistant (PDA), digital music player, watch, and wearable device, and/or other type of battery-powered electronic device.

The battery pack 100 can include a battery cell 102. The battery cell 102 includes a first stack of electrodes 103a-n and a first plurality of electrode tabs 106a-n extending from the first stack of electrodes 103a-n. Each electrode in the first stack of electrodes 103a-n can be an anode layer. Each electrode tab of the first plurality of electrode tabs 106a-n can be an anode current collector. Each anode current collector can be a material comprising at least one of copper and nickel, such as a copper and/or nickel foil.

The battery pack 100 can include an enclosure 104 enclosing the battery cell 102. The enclosure 104 can be a pouch or a hard container. The enclosure 104 can include a plurality of faces (e.g., sides). For example, the enclosure may comprise a top face, a bottom face, and one or more side faces. However, it should be appreciated that the enclosure may be any size or shape and may include any number of faces and/or angles. The battery pack 100 can include a feedthrough tab 120. The feedthrough tab 120 can form an external battery terminal, such as a negative battery terminal.

The battery pack 100 can include a lead tab 110. The lead tab 110 can include a first portion 112. The first portion 112 can be connected to the first plurality of electrode tabs 106a-n. The first portion 112 can be connected to the first plurality of electrode tabs 106a-n via an ultrasonic weld or any other suitable type of connection. The lead tab 110 can include a second portion 116. The second portion 116 can be connected to the feedthrough tab 120. The second portion 116 can be connected to the feedthrough tab 120 via a laser weld or any other suitable type of connection.

The lead tab 110 can include a third portion 114. The third portion 114 can connect the first portion 112 to the second portion 116 such that the first portion 112 and the second portion 116 at least partially overlap. The first portion 112 and the second portion 116 can reside in substantially separate parallel planes. The second portion 116 can be positioned substantially underneath the first portion 112, or vice versa. The first plurality of electrode tabs 106a-n can extend from the stack of electrodes 103a-n in a direction that is substantially parallel to both the first portion 112 and the second portion 116. The third portion 114 can be bent back over itself, such as to form a substantially 180 degree angle.

The first portion 112, the second portion 116, and the third portion 114 can collectively form a service loop in the feed-through region of the battery pack 100. The service loop can absorb a mechanical impact on the enclosure 104 to prevent a failure of the battery cell 102, such as if the battery pack 100 is dropped or otherwise subjected to an external force. Housing the service loop in the feed-through region of the battery pack 100 prevents the service loop from occupying any space in a region 145 between the battery cell 102 and an inner wall of the enclosure 104. Because the region 145 is unoccupied, the size of the electrodes can be increased, creating more active area, and thereby increasing the battery energy density. Further, housing the service loop in the feed-through region of the battery pack 100 instead of in the region 145 prevents deformation of the first plurality of electrode tabs 106a-n.

The term “substantially” used throughout this Specification is used to describe and account for small fluctuations. For example, it can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The battery cans, battery assemblies, and various non-limiting components and embodiments as described herein can be used with various electronic devices. Such electronic devices can be any electronic devices known in the art. For example, the device can be a telephone, such as a mobile phone, and a land-line phone, or any communication device, such as a smart phone, including, for example an iPhone®, and an electronic email sending/receiving device. The battery cans, battery assemblies, and various non-limiting components and embodiments as described herein can be used in conjunction with a display, such as a digital display, a TV monitor, an electronic-book reader, a portable web-browser (e.g., iPad®), watch and a computer monitor. The device can also be an entertainment device, including a portable DVD player, conventional DVD player, Blue-Ray disk player, video game console, music player, such as a portable music player (e.g., iPod®), etc. Devices include control devices, such as those that control the streaming of images, videos, sounds (e.g., Apple TV®), or a remote control for a separate electronic device. The device can be a part of a computer or its accessories, laptop keyboard, laptop track pad, desktop keyboard, mouse, and speaker.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A battery pack comprising:
a battery cell comprising:
a stack of electrodes; and
a plurality of electrode tabs extending from the stack of electrodes;
an enclosure enclosing the battery cell;
a feedthrough tab configured to form a battery terminal; and
a lead tab comprising:
a first portion connected to the plurality of electrode tabs;
a second portion connected to the feedthrough tab; and
a third portion connecting the first portion to the second portion such that the first portion and the second portion at least partially overlap and reside in substantially separate parallel planes, wherein the plurality of electrode tabs extend from the stack of electrodes in a direction that is substantially parallel to both the first portion and the second portion.

2. The battery pack of claim 1, wherein the third portion connecting the first portion to the second portion forms a substantially 180 degree angle.

3. The battery pack of claim 1, wherein each electrode tab of the plurality of electrode tabs is a cathode current collector.

4. The battery pack of claim 3, further comprising an insulator surrounding the feedthrough tab and configured to electrically isolate the feedthrough tab from the enclosure.

5. The battery pack of claim 3, wherein each cathode current collector is a material comprising aluminum.

6. The battery pack of claim 1, each electrode tab of the plurality of electrode tabs is an anode current collector.

7. The battery pack of claim 6, wherein each anode current collector is a material comprising at least one of copper and nickel.

8. The battery pack of claim 1, wherein the first portion is connected to the plurality of electrode tabs via ultrasonic welding.

9. The battery pack of claim 1, wherein the second portion is connected to the feedthrough tab via laser welding.

10. The battery pack of claim 1, wherein the first portion, the second portion, and the third portion of the lead tab form a service loop, wherein the service loop is configured to absorb a mechanical impact on the enclosure to prevent a failure of the stack of electrodes.

11. A method comprising:
connecting a first portion of a lead tab to a plurality of electrode tabs extending from a stack of electrodes;
connecting a second portion of the lead tab to a feedthrough tab configured to form a battery terminal; and
inserting the stack of electrodes within an enclosure by rotating a third portion of the lead tab around a fixed point such that the first portion and the second portion at least partially overlap and reside in substantially separate parallel planes, wherein the plurality of electrode tabs extend from the stack of electrodes in a direction that is substantially parallel to both the first portion and the second portion.

12. The method of claim 11, wherein the third portion connecting the first portion to the second portion is rotated around the fixed point such that the third portion forms a substantially 180 degree angle.

13. The method of claim 11, wherein the third portion connects the first portion to the second portion.

14. The method of claim 11, wherein each electrode tab of the plurality of electrode tabs is a cathode current collector.

15. The method of claim 14, wherein each cathode current collector is a material comprising aluminum.

16. The method of claim 11, wherein each electrode tab of the plurality of electrode tabs is an anode current collector.

17. The method of claim 16, wherein each anode current collector is a material comprising at least one of copper and nickel.

18. The method of claim 11, wherein connecting the first portion of the lead tab to the plurality of electrode tabs extending from the stack of electrodes comprises attaching the first portion of the lead tab to the plurality of electrode tabs extending from the stack of electrodes via ultrasonic welding.

19. The method of claim 11, wherein connecting the second portion of the lead tab to the feedthrough tab comprises laser welding the second portion of the lead tab to the feedthrough tab.

20. The method of claim 11, wherein the first portion, the second portion, and the third portion of the lead tab form a service loop, wherein the service loop is configured to absorb a mechanical impact on the enclosure to prevent a failure of the stack of electrodes.
